(19) United States
(12) Patent Application Publication
(10) Pub. No.: US 2024/0400061 A1
(43) Pub. Date: Dec. 5, 2024

(54) Method for Determining a Speed Value of a Single-Track Vehicle

(71) Applicant: Robert Bosch GmbH, Stuttgart (DE)

(72) Inventors: David Gabriel, Walddorfhaeslach (DE); Johann Skatulla, Reutlingen (DE)

(21) Appl. No.: 18/733,120

(22) Filed: Jun. 4, 2024

(30) Foreign Application Priority Data
Jun. 5, 2023 (DE) 10 2023 205 207.5

(51) Int. Cl. B60W 40/105

(52) U.S. Cl. CPC B60W 40/105; B60W 2520/105; B60W 2520/14

(57) ABSTRACT

A method for determining a speed value of a single-track vehicle, in particular an eBike, is disclosed. The vehicle has at least one acceleration sensor and one rotation rate sensor. The method includes (i) measuring the acceleration of the vehicle in at least three directions using the acceleration sensor, (ii) measuring a rotation rate of the vehicle about at least two rotation axes using the rotation rate sensor, (iii) determining a driving situation of the vehicle based on the measured accelerations and rotation rates of the vehicle, and (iv) determining the speed value of the vehicle using a system of equations describing the kinematics of the vehicle, the determined driving situation and the measured accelerations and rotation rates of the vehicle.

This application claims priority under 35 U.S.C. § 119 to patent application no. DE 10 2023 205 207.5, filed on Jun. 5, 2023 in Germany, the disclosure of which is incorporated herein by reference in its entirety.

The disclosure relates to a method for determining a speed value of a single-track vehicle, in particular an eBike, wherein the vehicle has at least one acceleration sensor and one rotation rate sensor.

The disclosure also relates to a method for checking the plausibility of a speed value of a single-track vehicle, in particular an eBike.

Furthermore, the disclosure relates to a single-track vehicle, in particular an eBike, comprising at least one acceleration sensor and one rotation rate sensor.

Although generally applicable to single-track vehicles, the following disclosure is explained with reference to eBikes.

### BACKGROUND

It has become common practice for eBikes to use a pulse-based sensor, or pulse sensor for short, on the rear wheel to measure speed. This provides a pulse per wheel revolution on the basis of which a speed can be calculated using the wheel circumference. This signal is used in a familiar way to reduce driver assistance above a certain speed, for example to comply with legal requirements. In the event of a defective or faulty sensor, the incorrectly determined speed must be detected and/or corrected using another sensor.

### SUMMARY

In one embodiment, the present disclosure provides a method for determining a speed value of a single-track vehicle, in particular an eBike, wherein the vehicle comprises at least an acceleration sensor and a rotation rate sensor, comprising the steps of:
measuring the acceleration of the vehicle in at least three directions using the acceleration sensor,
measuring a rotation rate of the vehicle about at least two rotation axes using the rotation rate sensor, determining a driving situation of the vehicle based on the measured accelerations and rotation rates of the vehicle, and
determining the speed value of the vehicle using a system of equations describing the kinematics of the vehicle, the determined driving situation and the measured accelerations and rotation rates of the vehicle.

In one embodiment, the present disclosure provides a method for plausibilizing a speed value of a single-track vehicle, in particular an eBike, comprising the steps of:
determining a speed value of the vehicle by a method according to the present disclosure,
determining a further speed value of the vehicle using a further speed sensor, and
plausibility check of the further speed value based on a comparison of the determined speed value and the determined further speed value.

In one embodiment, the present disclosure provides a single-track vehicle, in particular an eBike, comprising at least one acceleration sensor and one rotation rate sensor, and:
a measuring unit designed to measure an acceleration of the vehicle in at least three directions by means of the acceleration sensor and to measure a rotation rate of the vehicle about at least two rotation axes by means of the rotation rate sensor,
an determining unit designed to determine a driving situation of the vehicle on the basis of the measured accelerations and rotation rates of the vehicle, and
a determination unit designed to determine a speed value of the vehicle using a system of equations describing the kinematics of the vehicle, the determined driving situation and the measured accelerations and rotation rates of the vehicle.

In other words, in one embodiment, the accelerations of the vehicle in at least three directions and the rotation rates of the vehicle about at least two axes of rotation are measured first. Based on the acceleration and rotation rates determined, a current driving situation can be recognized, for example cornering. In a suitable driving situation, a system of equations can be set up and solved so that the speed of the vehicle can be calculated as a function of the accelerations and rotation rates.

The term “speed value” is to be understood in the broadest sense and refers in the description, preferably in the claims, to an amount of a speed. In particular, the speed value is determined when determining a speed.

The expression “measuring an acceleration of the vehicle in at least three directions” is to be understood in the broadest sense and refers in the description, preferably in the claims, to the determination of an acceleration of the vehicle in different directions. In particular, the acceleration of the vehicle is measured in three directions, wherein the three directions are preferably perpendicular to each other.

One of the advantages of this is that the speed or speed value of the vehicle can be detected using an alternative sensor. A further advantage is that the speed or speed value can be determined using an inexpensive acceleration sensor. Another advantage is that the speed values determined by the further speed sensor can be checked for plausibility so that faulty speed signals can be detected.

Further features, advantages and other embodiments of the disclosure are described in the following or are thereby disclosed.

According to an advantageous further development of the disclosure, the driving situation of the vehicle is a straight-ahead driving accelerated in the direction of driving, a straight-ahead driving not accelerated in the direction of driving, a cornering drive accelerated in the direction of driving, a cornering drive not accelerated in the direction of driving or a standstill. The driving situation can be determined depending on the measured accelerations and rotation rates. Depending on the driving situation, the speed value of the vehicle can be determined using the equation system. For example, the speed value can be calculated when cornering, but not when stationary. One advantage of this is that a decision can be made as to whether or not to determine the speed once the driving situation has been determined. Another advantage is that the speed value can be calculated more easily, as in some driving situations—for example when cornering without acceleration in the direction of driving—the calculation of the speed is simplified.

According to an advantageous further development of the disclosure, the speed value is only determined during cornering. During cornering, the vehicle's rotation rates are usually not equal to zero. In this case, the speed can be determined particularly precisely. One advantage of this is that the speed value is only determined if an exact determination of the speed value can be made.

According to an advantageous further development of the disclosure, the at least three directions are a direction of driving, a transverse direction and/or a vertical direction of the vehicle. In particular, the direction of driving can be parallel to a straight line through the centers of the vehicle's wheels. In particular, the vertical direction can be parallel to a straight line that is perpendicular to the direction of driving and passes through a saddle of the vehicle. In particular, the vertical direction can be parallel to a vertical of a surface over which the vehicle is driving. In particular, the transverse direction can be parallel to a straight line that is perpendicular to the direction of driving and the vertical direction. For example, the acceleration sensor can be arranged on a frame of the vehicle so that the acceleration sensor can directly measure the accelerations in the driving, upward and transverse directions. One advantage of this is that the determined accelerations can be used directly to determine the speeds without having to rotate them into a different coordinate system.

According to an advantageous further development of the disclosure, the at least two axes of rotation are axes parallel to the transverse direction and/or along the vertical direction of the vehicle One advantage of this is that the speed value can be calculated easily, as the speed value of the vehicle depends on the rotation rates around these axes.

According to an advantageous further development of the disclosure, the system of equations is based on the speed of the vehicle in the rolling direction and an acceleration of the vehicle in the rolling direction. If the system of equations is dependent on the speed and acceleration of the vehicle in the rolling direction, especially if these variables or values are not equal to zero, the speed cannot be determined by solving a linear system of equations. In this case, however, it is possible to determine the speed by solving a differential equation that includes both the acceleration and the speed of the vehicle. One advantage of this is that the speed of the vehicle can be determined in several driving situations.

According to an advantageous further development of the disclosure, the system of equations is based on the measured accelerations and rotation rates, a pitch angle and a yaw angle. One advantage of this is that the speed can be determined more precisely.

According to an advantageous further development of the disclosure, the plausibility check of the further speed value is carried out using a reliability indicator of the determined speed value. Depending on the driving situation, the speed determined using the acceleration and rotation rates can vary in accuracy. Accordingly, a speed determined by means of the further speed sensor could be correct even if the difference between the determined speed and the determined speed is large. The reliability indicator can indicate how accurate the speed determined using the acceleration and rotation rates is in the current driving situation and whether this should be used to check the plausibility of the further speed value. One advantage of this is that implausible speed values can be better recognized and discarded.

According to an advantageous further development of the disclosure, the reliability indicator is based on a Kalman filter, a sensitivity analysis and/or a comparison of the measured accelerations and rotation rates with a limit value. For example, a sensitivity analysis can be used to determine limit values for the measured accelerations and rotation rates, within which the determined speed values are considered accurate. It is also conceivable that the covariance matrix of the Kalman filter is used directly as a quality measure of the determined speed value. If this quality is better than a threshold value, the determined speed signal is considered accurate. This could advantageously prevent the speed values determined by the further speed sensor from being incorrectly declared as implausible.

According to an advantageous further development of the disclosure, the comparison of the determined speed value and the determined further speed value is based on an average value comparison, a surface weight comparison and/or a threshold value comparison with error counter. To compare the speed values, for example, both speed values can be measured for a certain period of time. The mean values of the respective speed values are then measured and compared with each other. It is also conceivable that the number of times is determined at which the difference between the two speed values is greater than a threshold value. If this number is greater than further threshold value, the determined speed signal is considered implausible. It is also possible, for example, that implausible speed values are determined based on the surface weight. For example, a graph of the determined speed values is generated and the area under the courses of the speed values is determined and compared. One advantage of this is that the speed values are compared over a period of time so that individual dropouts do not play a role in determining the speed signal.

Further important features and advantages of the disclosure can be seen from the drawings and from the associated description of the figures.

It is understood that the features specified hereinabove and those yet to be explained hereinafter can be used not only in the combination indicated in each case, but also in other combinations or on their own, without departing from the scope of the present disclosure.

### BRIEF DESCRIPTION OF THE DRAWINGS

Preferred designs and embodiments of the present disclosure are shown in the drawings and are explained in more detail in the following description.

Shown in schematic form are:

FIG. 1 steps of a method according to one embodiment of the present disclosure;

FIG. 2 steps of a method according to one embodiment of the present disclosure,

FIG. 3 a progression of speed values according to an embodiment of the present disclosure, and

FIG. 4 a vehicle speed values according to an embodiment of the present disclosure.

### DETAILED DESCRIPTION

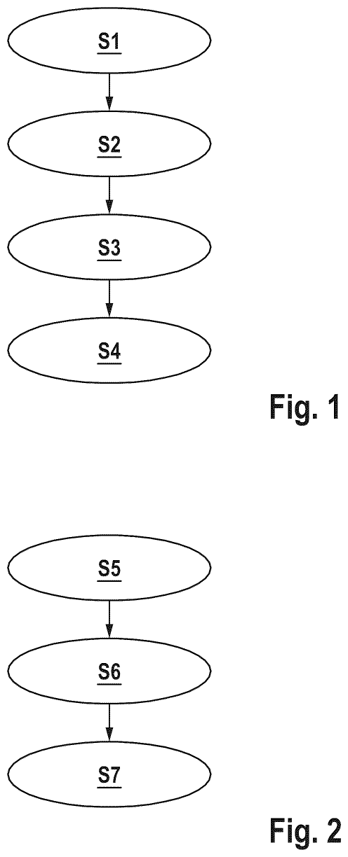

FIG. 1 schematically shows steps of a method according to an embodiment of the present disclosure.

The method according to FIG. 1 can be used to determine the speed or the speed value of a single-track vehicle, wherein the vehicle has at least one acceleration sensor and one rotation rate sensor.

In a step S1, an acceleration of the vehicle is measured in at least three directions by means of the acceleration sensor. The three directions are the direction of driving, up and transverse direction. In other words, the accelerations are measured in the direction of driving, perpendicular to the direction of driving and transverse to the direction of driving. The acceleration sensor can be an IMU. The orientation of the acceleration sensor in relation to the vehicle is known when the acceleration sensor is permanently installed so that the directions are constant.

In a step S2, a rotation rate of the vehicle about at least two rotation axes is measured by means of the rotation rate sensor. The axes of rotation correspond to the driving, vertical and transverse direction of the vehicle. In particular, the rotation rate around the transverse axis and the vertical axis is measured. It is also conceivable that the rotation rate is measured around all three axes.

In a further step S3, a driving situation of the vehicle is determined using the measured accelerations and rotation rates of the vehicle. The driving situation influences whether and how accurately the speed can be determined using the method. For example, it is easier to determine the speed when cornering than when driving straight ahead. The driving situation could be, for example, cornering, straight-ahead driving or a standstill. In particular, the driving situation could be determined based on the amount of rotation rates. If, for example, a rotation rate, in particular around the vertical or transverse axis, is greater than a threshold value, the speed can be determined. In particular, it can be required that both rotation rates around the vertical and transverse axes are greater than one threshold value each, as in each case both rotation rates are greater than zero during normal cornering.

In a further step S4, the speed value of the vehicle is determined using a system of equations describing the kinematics of the vehicle, the determined driving situation and the measured accelerations and rotation rates of the vehicle. In particular, the speed of the rear wheel of the vehicle is determined. It is assumed that the rear wheel is a non-holonomic system. This means that there are no or only insignificantly small speed components perpendicular to the running direction when rolling.

The system of equations is:

$${\dot{V}}_{f} - {A}_{b x} + g \cdot sin ( θ ) = 0$$

$${V}_{f} \cdot {ω}_{z} - {A}_{b y} - g \cdot sin ( φ ) \cdot cos ( θ ) = 0$$

$${V}_{f} \cdot {ω}_{y} - {A}_{b z} + g \cdot cos ( φ ) \cdot cos ( θ ) = 0$$

The following applies:
\dot{V}_{f}: Beschleunigung in Abrollrichtung
V_{f}: die gesuchte Geschwindigkeit in Abrollrichtung A_{bx}, A_{by}, A_{bz}: The measured accelerations in the driving, transverse and vertical directions
ω_{y}, ω_{z}: Die Drehraten um die Quer—und Hochrichtung
φ, θ: Nickwinkel und Rollwinkel des Fahrzeugs

The speed value can be calculated differently depending on the driving situation, i.e. depending on the measured accelerations and rotation rates:

If the acceleration in the direction of driving is zero and the rotation rates around the vertical and transverse axes are not equal to zero, the roll and pitch angles can be determined directly from the accelerations and rotation rates. This is the case, for example, when driving straight ahead.

If the acceleration in the direction of driving is zero and one of the rotation rates is not equal to zero, the speed value in the direction of driving can be calculated directly. This is the case when cornering, for example.

If the acceleration in the direction of driving is not zero and at least one rotation rate is not equal to zero, a differential equation can be set up for the speed in the direction of driving. This can therefore be observed, which enables the use of a status observer and the bridging of further driving situations.

In particular, the two driving situations of accelerated straight-ahead driving and unaccelerated straight-ahead driving can be bridged. In these driving situations, the speed in the direction of driving cannot be calculated directly. However, single-track vehicles can behave like inverse pendulums and thus exhibit unstable driving physics. To correct this instability, short cornering runs are regularly required during which the speed can be observed and thus calculated. This means that the speed can also be determined while driving straight ahead.

Depending on the driving situation, the speed value of the vehicle can therefore be determined solely from the measured values of the acceleration sensor and the rotation rate sensor.

FIG. 2 shows in schematic form steps of a method according to one embodiment of the present disclosure.

The method shown in FIG. 2 can be used to check the plausibility of a speed value of a single-track vehicle.

In a step S5, a speed value of the vehicle is determined using a method according to the present disclosure. The speed value is determined in particular using steps S1 to S4 as shown in FIG. 1.

In a further step S6, a further speed value of the vehicle is determined using a further speed sensor. The further speed sensor can be a pulse-based speed sensor, in particular a reed sensor, for example. This speed value could be incorrect due to faults or malfunctions.

Therefore, in a step S7, this determined further speed value is checked for plausibility by comparing the determined speed value and the determined further speed value.

It is possible that the plausibility check of the determined further speed value is only carried out if a suitable driving situation has been detected. For example, the plausibility check can only be carried out if a cornering movement has been detected. It is also conceivable that limit values for the measured accelerations and rotation rates are stored in the vehicle and only the determined speed value is checked for plausibility if the measured accelerations and rotation rates are within the limit values. In particular, the plausibility check can only be carried out if a minimum rotation rate has been detected. In addition, the plausibility check can only be carried out if the determined speed is within a specific speed range, for example between 5 km/h and 50 km/h, advantageously between 10 km/h and 40 km/h, in particular between 20 km/h and 30 km/h.

To check the plausibility, the determined speed value can be compared with the determined speed value. If the difference between the speed values is less than a limit value, the determined speed value is considered plausible. It is possible that the limit value is dependent on the driving situation; for example, the limit value could be higher when driving straight ahead, as greater deviations between the determined speed value and the determined further speed value are expected when driving straight ahead. It is also conceivable that in each case a further speed value is determined at several points in time and a speed value is determined. In this case, for example, an average of the speed values can be compared.

It is also conceivable that a quality measure is determined using the covariance matrix of a Kalman filter, wherein the quality measure is compared with a limit value.

If the further speed value determined is classified as implausible, it can be assumed that the speed signal from the further speed sensor is faulty. In this case, follow-up measures can be initiated. For example, a message may be displayed indicating that the speed sensor is faulty. It is also conceivable that drive assistance for the vehicle is deactivated if a speed value is classified as implausible.

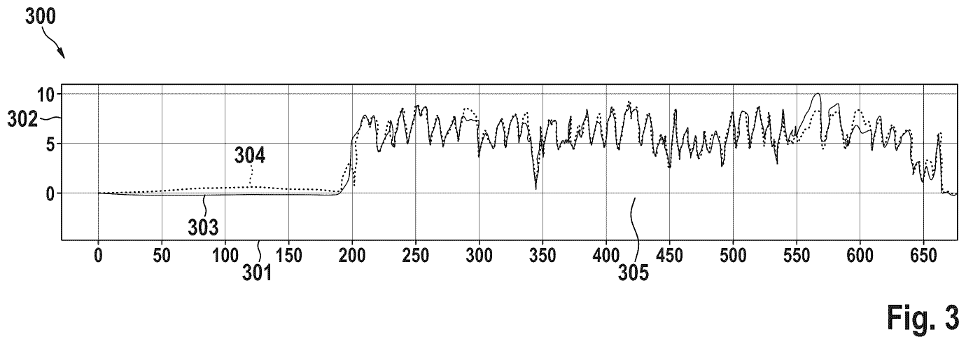

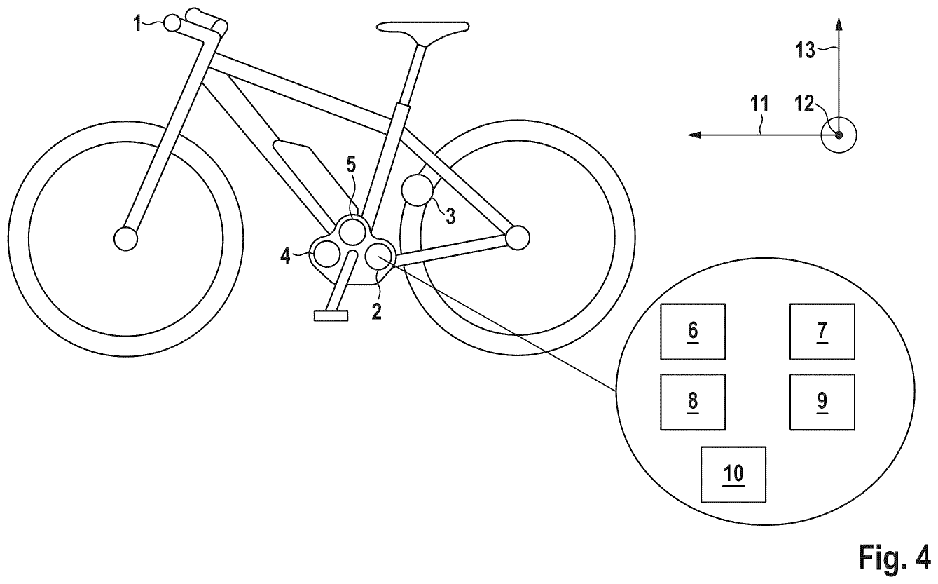

FIG. 3 shows in schematic form a progression of speed values according to one embodiment of the present disclosure.

Diagram 300 shows a progression of speed values. The X-axis 301 shows the time in milliseconds and the Y-axis 302 shows the speed in meters per second. The progression of determined speed values 303 and determined further speed values 304 is shown. By comparing the curves 303, 304, it is possible to recognize whether the curve of the further speed values 304 determined is plausible. For easier comparison, the curves of the speed values 303, 304 could be filtered using a low-pass filter.

For example, the moving average of the curves 303, 304 could be determined for comparison. If the moving averages show a deviation of less than a threshold value, the determined speed values are considered plausible.

It is also conceivable that the area 305 between the courses 303, 304 and the X-axis 301 is determined and compared.

FIG. 4 shows in schematic form a vehicle according to one embodiment of the present disclosure.

The vehicle 1, here in the form of an eBike, comprises a drive unit 2, a further speed sensor 3, an acceleration sensor 4 and a rotation rate sensor 5.

Furthermore, the vehicle 1 comprises a measuring unit 6, designed to measure an acceleration of the vehicle 1 in at least three directions by means of the acceleration sensor 4 and to measure a rotation rate of the vehicle 1 about at least two rotation axes by means of the rotation rate sensor 5. The three directions are, in particular, the direction of driving 11, the transverse direction 12 and the vertical direction 13. In particular, the axes of rotation are parallel to the transverse direction 12 and the vertical direction 13.

In addition, the vehicle 1 comprises an determining unit 7, designed to determine a driving situation of the vehicle 1 using the measured accelerations and rotation rates of the vehicle 1, and a determination unit 8, designed to determine the speed of the vehicle 1 using a system of equations describing the kinematics of the vehicle, the determined driving situation and the measured accelerations and rotation rates of the vehicle 1.

In particular, the vehicle 1 is designed to determine the speed value of the vehicle 1 by means of a method according to steps S1 to S4 as shown in FIG. 1.

Furthermore, the vehicle 1 comprises a second measuring unit 9, which is designed to determine the speed of the vehicle 1 by means of the further speed sensor 3. In addition, a plausibility check unit 10 is arranged, which is designed to check the plausibility of a speed value of the further speed sensor 3 by comparing the further speed value and the determined speed value.

In particular, the vehicle 1 is designed to check the plausibility of speed values determined by means of the further speed sensor 3 using a method in accordance with steps S5 to S7 as shown in FIG. 2.

If a speed value of the further speed sensor 3 is classified as implausible by the plausibility check unit 10, assistance from the drive unit 2 can be reduced or suspended, for example.

Acceleration 4 and/or rotation rate sensors 5 are usually installed per se, especially on eBikes. Vehicle 1 as shown in FIG. 4 can therefore be used to check the plausibility of the speed or speed value of vehicle 1 without the need for additional sensors.

In summary, the present disclosure has at least one of the following advantages and/or provides the following features:
Cost-effective determination of the speed of a vehicle,
Simple plausibility check of a pulse-based speed sensor,
Provision of an alternative method for determining the speed.

Even though the present disclosure has been described with reference to preferred embodiment examples, it is not limited to these and can be modified in a variety of ways.

What is claimed is:

1. A method for determining a speed value of a single-track vehicle, wherein the vehicle has an acceleration sensor and a rotation rate sensor, the method comprising:
measuring an acceleration of the vehicle in at least three directions by way of the acceleration sensor;
measuring a rotation rate of the vehicle about at least two rotation axes by way of the rotation rate sensor;
determining a driving situation of the vehicle on the basis of the measured accelerations and rotation rates of the vehicle; and
determining the speed value of the vehicle using a system of equations describing the kinematics of the vehicle, the determined driving situation and the measured accelerations and rotation rates of the vehicle.

2. The method according to claim 1, wherein the driving situation of the vehicle is a straight-ahead driving accelerated in the direction of driving, a straight-ahead driving not accelerated in the direction of driving, a cornering drive accelerated in the direction of driving, a cornering drive not accelerated in the direction of driving or a standstill.

3. The method according to claim 2, wherein the speed value is determined only during cornering.

4. The method according to claim 1, wherein the at least three directions are a driving direction, a transverse direction and/or a vertical direction of the vehicle.

5. The method according to claim 4, wherein the at least two axes of rotation are axes along the transverse direction and/or parallel to the vertical direction of the vehicle.

6. The method according to claim 1, wherein the system of equations is based on the speed of the vehicle in the rolling direction and an acceleration of the vehicle in the rolling direction.

7. The method according to claim 1, wherein the system of equations is based on the measured accelerations and rotation rates, a pitch angle and a yaw angle.

8. A method for checking the plausibility of a speed value of a single-track vehicle, comprising:
determining a speed value of the vehicle using a method according to claim 1;
determining a further speed value of the vehicle using a further speed sensor; and
performing a plausibility check of the further speed value based on a comparison of the determined speed value and the determined further speed value.

9. The method according to claim 8, wherein the plausibility check of the further speed value is carried out using a reliability indicator of the determined speed value.

10. The method according to claim 9, wherein the reliability indicator is based on a Kalman filter, a sensitivity analysis and/or a comparison of the measured accelerations and rotation rates with a limit value.

11. The method according to claim 8, wherein the comparison of the determined speed value and the determined further speed value is based on a mean value comparison, a surface weight comparison and/or a threshold value comparison with error counter.

12. A single-track vehicle, comprising:
an acceleration sensor;
a rotation rate sensor;
a measuring unit designed to measure (i) an acceleration of the vehicle in at least three directions by way of the acceleration sensor, and (ii) a rotation rate of the vehicle about at least two rotation axes by way of the rotation rate sensor;
a determining unit designed to determine a driving situation of the vehicle on the basis of the measured accelerations and rotation rates of the vehicle; and
a determination unit designed to determine a speed value of the vehicle on the basis of a system of equations describing the kinematics of the vehicle, the determined driving situation and the measured accelerations and rotation rates of the vehicle.

13. The method according to claim 1, wherein the single-track vehicle is an eBike.

14. The method according to claim 8, wherein the single-track vehicle is an eBike.

15. The single-track vehicle according to claim 12, wherein the single-track vehicle is an eBike.
